(19) United States
(12) Patent Application Publication
(10) Pub. No.: US 2006/0272589 A1
(43) Pub. Date: Dec. 7, 2006

(54) Device and assembly for removably securing a dish to a tray

(76) Inventor: David R. Cheney, Clearwater, FL (US)

Correspondence Address: Raymond M. Galasso;Galasso & Associates LP, P.O. Box 26503, Austin, TX, 78755-0503, US

(21) Appl. No.: 11/144,191

(22) Filed: Jun. 4, 2005

(51) Int. Cl. A01K 5/01; A01K 1/10

(52) U.S. Cl. 119/61.54

(57) ABSTRACT

A dish that can be releasably secured to a base, such as a table or tray. The dish includes compressible tabs that extend from the bottom of the dish. The tabs are to be compressed and inserted into a hole in the base. Once the tabs extend beyond the hole, the tabs return to a more uncompressed state, and engage the base. This secures the dish to the base. A two piece, threaded reinforcement can first be inserted to the hole in the base and secured together. The reinforcement includes a hole extending therethrough for receiving the tabs of the dish. A seal can also be positioned intermediate the dish and the base to prevent items, such as food and liquid from entering the hole.

### FIELD OF THE INVENTION

The present invention relates to dishes, and more particularly, but not by way of limitaion to a dish that can be removably secured to a tray, such as a highchair tray.

### BACKGROUND OF THE INVENTION

One area of baby care that can be especially challenging for parents is feeding time. As most infants begin eating solid foods between the ages of four and six months, this coincides with the time when babies are beginning to experiment with the hands and mouths. Infants quickly learn that they can grab onto a bowl and either dump the contents out onto the tray or worse, throw it, along with the contents onto the floor or other surrounding furniture. As infants make the transition to toddlers, they being feeding themselves. Without constant supervision by parents, however, as with infants, the food dish often finds its way onto the floor or the contents are dumped.

Children need to learn the fine motor skills that are necessary to feed themselves. They need practice eating from a bowl using a spoon or fork. Parents sometimes are wary of providing this practice because of the mess that is made. It is sometimes easier to feed the child than to let child feed themselves and possibly create a huge mess. Some products have been designed which seek to eliminate this problem. They include bowls that have suction cups on the bottom to stick the bowl to the highchair tray. Unfortunately, these suction cups often lose suction and the bowl once again ends up on the floor. Sometimes the suction cups are difficult to remove and the pulling and tugging required to remove the bowl means its contents end up on the floor anyway. Even more frustrating is when the suction cups just won't stick despite a parent's best efforts. It would be advantageous therefore, to develop a dish or bowl that can be readily secured to the tray of a highchair that will prevent a child from spilling and throwing the bowl, but yet can also be readily removed by the parent.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention with portions shown in exploded view; and

FIG. 2 is a cross-section view of the present invention taken along line A-A.

### DETAILED DESCRIPTION

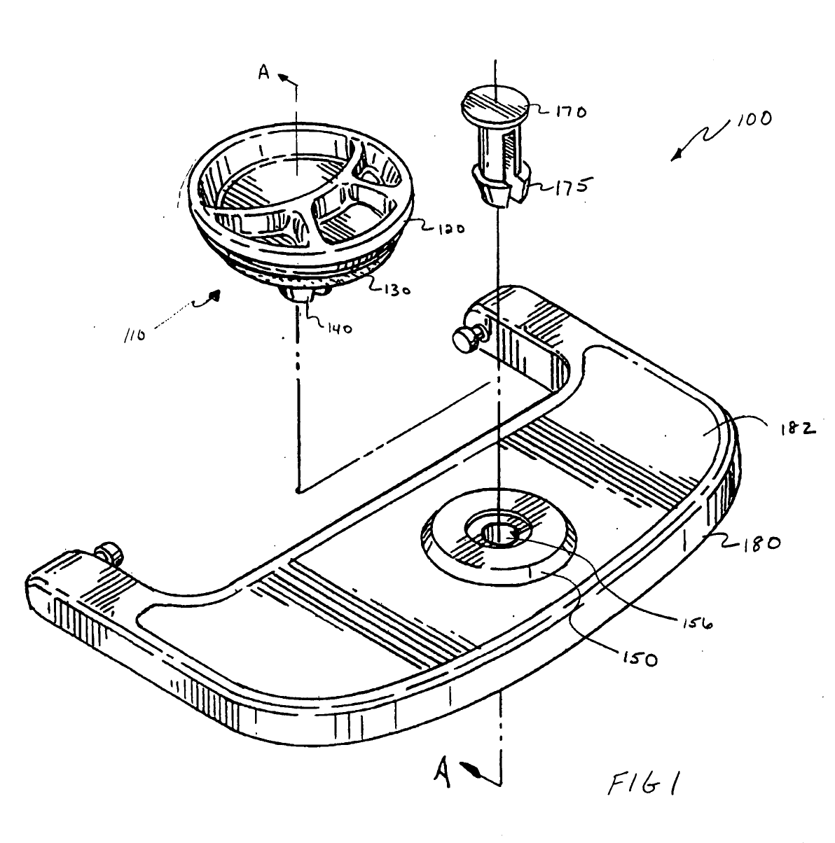

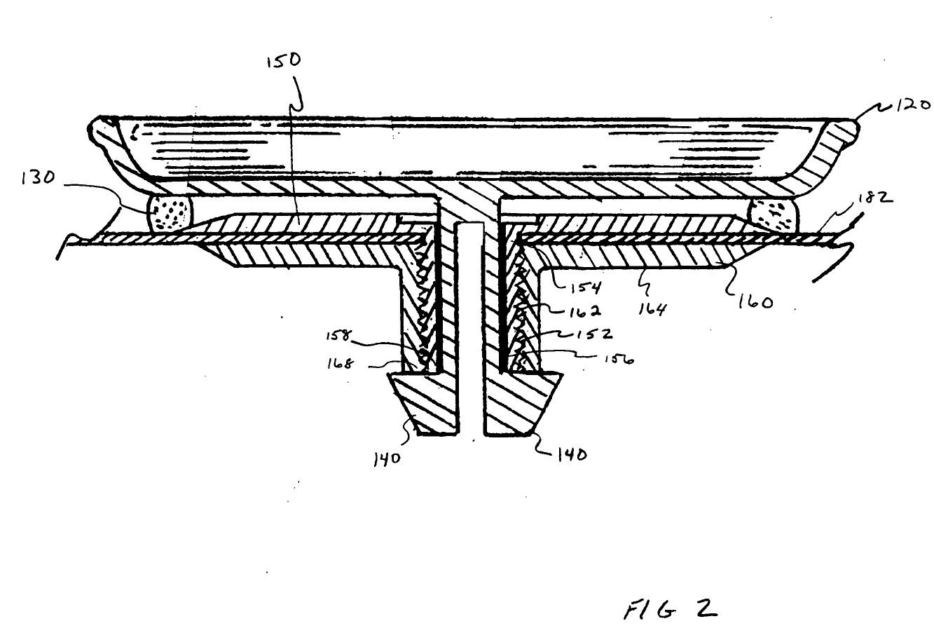

Referring now to the drawings wherein like or similar elements are designated with identical reference numerals throughout the views and figures, and wherein the various elements depicted are not necessarily drawn to scale, and in particular, to FIG. 1, there is shown an feeding dish system 100. The feeding dish system 100 includes a dish or plate 110, a hole cover 170 and a tray 180 (such as a high chair tray). As illustrated dish 110 includes tray portion 120, a seal 130, and squeeze tabs 140. Hole cover 170 includes squeeze tabs 175. Tray 180 includes an upper reinforcement 150 and a lower reinforcement 160 (see FIG. 2). As can be appreciated, dish 110 could be made of various materials, however, good results have been achieved utilizing food grade plastic that is accepted as safe for use in food preparation and consumption, shatter resistant, nonporous, and dishwasher safe for easy cleanup and disinfecting.

Referring now to FIG. 2, there is illustrated a cross sectional view of the feeding dish system 100 with dish 110 removably attached to tray 180. As illustrated upper reinforcement 150 is generally circular shaped and includes a threaded portion 152 extending from the upper portion 154, with a hole 156 extending through the center of upper reinforcement 150. Lower reinforcement 160 is also generally circular shaped with a mating threaded portion 162 for engagement with threaded portion 152 of upper reinforcement 150. Threaded portion 162 extends from the upper portion 164 of lower reinforcement 160. As further illustrated, dish 120 includes squeeze tabs 140 that extend from the bottom of dish 120 for insertion into the hole 156 of upper reinforcement 150.

Referring now to both FIGS. 1 and 2, the assembly and operation of a preferred embodiment of feeding dish system 100 will now be described. In this preferred embodiment a hole is initially created in tray 180. The size of the hole is to correspond with the sizes of the hole 156 of upper reinforcement 150, lower reinforcement 160, and squeeze tabs 140. Once the hole is created, the treaded portion 152 of upper reinforcement 150 is inserted into the hole such that the upper portion 154 of upper reinforcement 150 contacts the top side 182 of tray 180. The threaded portion 162 of lower reinforcement 160 is aligned to be mated with the threaded portion 152 of upper reinforcement 150 on the bottom side 184 of tray 180. Lower reinforcement 160 is then threaded onto upper reinforcement 150 until lower reinforcement 160 comes into contact with the bottom side 184 of tray 180. Lower reinforcement 160 is to be screwed on to upper reinforcement 150 such that tray 180 is securely positioned there between.

Once the upper reinforcement 150 and lower reinforcement 160 are secured to tray 180, the seal 130 is placed over squeeze tabs 140 of dish 110. The squeeze tabs 140, which are normally biased apart, are pinched or compressed together such that they can be inserted into the hole 156 of upper reinforcement 150. Once squeeze tabs 140 extend beyond the threaded portions 152 and 162 of upper reinforcement 150 and lower reinforcement 160 respectively tabs 140 return to their biased position and engage both the lower portion 158 of upper reinforcement 150 and the lower portion 168 of lower reinforcement 160. Seal 130 is secured between dish portion 130 and upper reinforcement 150 to provide a seal or barrier to prevent items such as food and liquids from leaking underneath dish 110 and from falling into hole 156 of upper reinforcement 150. Good results have been achieved utilizing a neoprene seal for seal 130.

In removing dish 110, tabs 140 are compressed or squeezed together, such that they can inserted back into the hole 156 of upper reinforcement 150, thereby permitting the removal tabs 140 from hole 156 and thus the removal of dish 110.

If desired, to cover the hole 156 of upper reinforcement 150 when dish 110 is not inserted therein, hole cover 170 could be used. Similar to dish 110, squeeze tabs 175, which are normally biased apart, are compressed or squeezed together and inserted into the hole 156 of upper reinforcement 150. Once squeeze tabs 175 extend beyond the threaded portions 152 and 162 of upper reinforcement 150 and lower reinforcement 160 respectively, tabs 175 return to their biased position and engage the lower portion 158 of upper reinforcement 150 and lower portion 168 of lower reinforcement 160.

In removing hole cover 170, tabs 175 are compressed or squeezed together, such that they can inserted back into the hole 156 of upper reinforcement 150. The permits tabs 175 of hole cover 170 to be removed therefrom.

Although the described preferred embodiment incorporates upper reinforcement 150 and lower reinforcement 160 with a hole created in tray 180, it is contemplated to be within the scope of this invention that tray 180 could be of sufficient thickness to accept dish 110 with tabs 140 engaging tray 180 upon insertion without upper reinforcement 150 and lower reinforcement 160.

Further, although in the described preferred embodiment, dish 110 can be secured to a tray such as a high chair tray, it is contemplated to be within the scope of this invention that dish 110 could also be secured to other types of trays and tables; such as the tray used in airplanes and jets; tables and trays used in boats; a tray connected to a car seat; or virtually anywhere it is beneficial to secure a dish to a table, tray or base upon which it is to be placed.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A spill resistant dish assembly, comprising:
a base having an upper portion and a lower portion, said base having a hole extending from said upper portion to said lower portion; and
a receptacle for receiving items therein, said receptacle having a lower portion, said receptacle further including compressible tabs extending from said lower portion of said receptacle, said compressible tabs for insertion into said hole of said base and further for removable securing said receptacle to said base.

2. The spill resistant dish assembly as recited in claim 1, and further including a reinforcement device extending through said hole of said base, said reinforcement device having a hole for receiving said compressible tabs of said receptacle.

3. The spill resistant dish assembly as recited in claim 1, and further including a seal for placement between said lower portion of said receptacle and said upper portion of said base.

4. The spill resistant dish assembly as recited in claim 3, wherein said seal is generally annular in shape and is further positioned about said hole of said base.

5. The spill resistant dish assembly as recited in claim 2, and further including a seal for placement between said lower portion of said receptacle and said reinforcement device.

6. The spill resistant dish assembly as recited in claim 5, wherein said seal is generally annular in shape and is further positioned about said hole of said reinforcement.

7. A dish and tray assembly, comprising:
a tray having an upper portion and a lower portion, said tray having a hole extending between said upper portion and said lower portion; and
a dish having a lower portion, said dish including securing mechanism extending from said lower portion of said dish, said securing mechanism for insertion into said hole of said tray and for removable securing said dish to said tray.

8. The dish and tray assembly as recited in claim 7, a reinforcement releasably secured to said tray, said reinforcement having a hole for receiving said securing mechanism of said dish.

9. The dish and tray assembly as recited in claim 8, wherein said reinforcement includes an upper portion and a lower portion, wherein said tray is releasably secured between said upper and lower portions of said reinforcement.

10. The dish and tray assembly as recited in claim 9, wherein said upper portion of said reinforcement includes a threaded portion, and said lower portion of said reinforcement includes a threaded portion, wherein said threaded portion of said upper portion of said reinforcement receives said threaded portion of said lower portion of said reinforcement to releasably secured said reinforcement to said tray.

11. The dish and tray assembly as recited in claim 7, and further including a seal positioned between said tray and said dish.

12. The dish and tray assembly as recited in claim 11, wherein said seal is generally annular in shape and is positioned about said hole of said tray.

13. The dish and tray assembly as recited in claim 8, and further including a seal position between said dish and said reinforcement.

14. A dish that can be releasably secured to a base such as a table or tray, said dish comprising:
an upper portion and a lower portion; and
a plurality of compressible tabs extending from said lower portion, said compressible tabs for insertion into a hole in the base, said compressible tabs for releasably securing said dish to the base.

15. The dish as recited in claim 14, and further comprising a generally annular seal, said seal being positioned about said compressible tabs and adjacent to said lower portion, said seal further positioned between said base and said lower portion of said dish when said dish is secured to the base.

16. The dish as recited in claim 15, and further comprising reinforcement, said reinforcement for insertion into the hole of the base, said reinforcement including a hole for receiving said plurality of tabs.

17. The dish as recited in claim 16, wherein said reinforcement includes an upper portion and a lower portion, wherein said base is releasably secured between said upper and lower portions of said reinforcement.

18. The dish as recited in claim 17, wherein said upper portion of said reinforcement includes a threaded portion, and said lower portion of said reinforcement includes a threaded portion, wherein said threaded portion of said upper portion of said reinforcement receives said threaded portion of said lower portion of said reinforcement to releasably secure said reinforcement to said base.

19. The dish as recited in claim 18, wherein said seal positioned intermediate said lower portion of said dish and said upper portion of said reinforcement.

20. The dish as recited in claim 14, further comprising a reinforcement, said reinforcement for insertion into the hole of the base, said reinforcement including a hole for receiving said plurality of tabs;
said reinforcement further including an upper portion and a lower portion, wherein said base is releasably secured between said upper and lower portions of said reinforcement.
said upper portion of said reinforcement including a threaded portion, and said lower portion of said reinforcement including a threaded portion, wherein said threaded portion of said upper portion of said reinforcement receives said threaded portion of said lower portion of said reinforcement to releasably secure said reinforcement to said base.
